(19) United States
(12) Patent Application Publication
(10) Pub. No.: US 2024/0195712 A1
(43) Pub. Date: Jun. 13, 2024

(54) WORKLOAD IDENTIFICATION FOR IP ADDRESSES IN NETWORK TRAFFIC FLOW

(71) Applicant: VMWARE, INC., Palo Alto, CA (US)

(72) Inventors: DEVRAJ NARENDRA BAHETI, Santa Clara, CA (US); AMBARISH PRASHANT PANDE, Santa Clara, CA (US); AVINASH NIGAM, Lucknow (IN); VISHAL RANJAN, Pune (IN)

(21) Appl. No.: 18/119,842

(22) Filed: Mar. 10, 2023

(30) Foreign Application Priority Data
Dec. 13, 2022 (IN) 202241071961

(51) Int. Cl. H04L 43/026; H04L 45/745

(52) U.S. Cl. CPC H04L 43/026; H04L 45/745

(57) ABSTRACT

Embodiments for identifying workloads in a networking environment based on a flow record from an observation point are described. One embodiment of a method includes receiving network data from an endpoint in the networking environment, determining a plurality of administrative domains within the networking environment, and generating observation point mapping information that maps each observation point within the networking environment to one of the plurality of administrative domains. Some embodiments include generating a plurality of lookup tables, where a first lookup table is associated with a first administrative domain and where the first administrative domain corresponds to an L2 network that is disconnected from any router in the networking environment. Some embodiments include generating a workload identification table that maps combinations of IP addresses and administrative domains to workloads, receiving the flow record from the observation point, and identifying source and destination workloads of the flow record.

### RELATED APPLICATIONS

Benefit is claimed under 35 U.S.C. 119(a)-(d) to Foreign Application Serial No. 202241071961 filed in India entitled “WORKLOAD IDENTIFICATION FOR IP ADDRESSES IN NETWORK TRAFFIC FLOW”, on Dec. 13, 2022, by VMware, Inc., which is herein incorporated in its entirety by reference for all purposes

### BACKGROUND

Records of traffic flow are often captured in networking environments and used for the purposes of troubleshooting and analysis. For example, these records may be used to determine security policies, identify dependencies, migrate workloads (e.g., virtual machines (VMs), containers, other virtual computing instances (VCIs), and/or the like), allocate resources, and the like. In some cases, flow records may include information about network traffic, such as source and destination IP addresses and ports, protocol information, and the like. Flow records may be captured at various observation points (e.g., switches, routers, firewalls, physical machines, gateways, VCIs, and/or the like) within a networking environment and aggregated by a management entity for analysis.

As networks become more complex and heterogeneous, certain difficulties may arise in the process of analyzing flow records. For example, hybrid data systems may involve a variety of different types of independent networks with different isolation, bridging, routing and network translation mechanisms being employed for any given flow. For local functions, such as routing or address translation this does not pose a problem, as these functions operate only within the context of a particular isolated network. However, global functions such as flow traffic segregation and enrichment (i.e., using data from outside sources to add more detail or context to flow records) may present complex problems in hybrid networks, as flow records may be received centrally and need to be tied back to the local contexts of flow traversal paths.

One particular complex problem arises when a network has multiple workloads, but due to the particular network configuration, one or more of the workloads are not coupled to a router. Such workloads may be referred to as L3 disconnected workloads. Further, the network may include multiple environments, such as a production environment and a testing environment, which may be present under the same management entity. In certain cases, the same subnet IP address prefix may be used in different environments. Third-party network flow analysis systems may not be capable of accounting for such complexities. As such, third-party network flow analysis systems generally restrict themselves to IP address level analytics, and optionally provide enrichment restricted to simple network topology environments. Accordingly, there is a need in the art for improved methods of network flow enrichment in hybrid data systems.

It should be noted that the information included in the Background section herein is simply meant to provide a reference for the discussion of certain embodiments in the Detailed Description. None of the information included in this Background should be considered as an admission of prior art.

### SUMMARY

Technology for identifying workloads in a networking environment based on a flow record from an observation point are described herein and may be embodied in a method, system, or computer instructions encoded into a non-transitory machine readable medium for execution by a computer. One example method includes receiving network data from an endpoint in the networking environment, determining a plurality of administrative domains within the networking environment, and generating observation point mapping information that maps each observation point within the networking environment to one of the plurality of administrative domains. Some embodiments include generating a plurality of lookup tables, where a first lookup table is associated with a first administrative domain and where the first administrative domain corresponds to an L2 network that is disconnected from any router in the networking environment. Some embodiments include generating a workload identification table that maps combinations of IP addresses and administrative domains to workloads, receiving the flow record from the observation point, and identifying source and destination workloads of the flow record.

Embodiments of a system include at least one processor and at least one memory. The at least one processor and the at least one memory may be configured to cause the system to receive network data from one or more endpoints in the networking environment, where the network data comprises topology data and routing data, determine, based on the network data, a plurality of administrative domains within the networking environment, where each of the plurality of administrative domains comprises a distinct section of the networking environment within which every Internet Protocol (IP) address is unique, and generate, based on the network data, observation point mapping information that maps each observation point within the networking environment to one of the plurality of administrative domains. In some embodiments, the at least one processor and the at least one memory cause the system to generate, based on the network data, a plurality of lookup tables, where each of the plurality of lookup tables is associated with one of the plurality of administrative domains, where each of the plurality of lookup tables maps subnet IP address prefixes to administrative domains, where a first lookup table of the plurality of lookup tables is associated with a first administrative domain of the plurality of administrative domains, where the first administrative domain corresponds to an L2 network that is disconnected from any router in the networking environment. In some embodiments, the at least one processor and the at least one memory cause the system to generate, based on the network data, a workload identification table that maps combinations of IP addresses and administrative domains to workloads, receive the flow record from the observation point, and identify a source workload and a destination workload of the flow record using the observation point mapping information, the first lookup table, and the workload identification table.

Some embodiments include a non-transitory computer-readable medium for identifying workloads in a networking environment based on a flow record from an observation point. These embodiments of the non-transitory computer-readable medium may include instructions that, when executed by at least one processor of a computing system, cause the computing system to perform operations for virtual computing instance remediation that include receiving network data from one or more endpoints in the networking environment, where the network data comprises topology data and routing data, determining, based on the network data, a plurality of administrative domains within the networking environment, where each of the plurality of administrative domains comprises a distinct section of the networking environment within which every Internet Protocol (IP) address is unique, and generating, based on the network data, observation point mapping information that maps each observation point within the networking environment to one of the plurality of administrative domains. In some embodiments, the operations include generating, based on the network data, a plurality of lookup tables, where each of the plurality of lookup tables is associated with one of the plurality of administrative domains, where each of the plurality of lookup tables maps subnet IP address prefixes to administrative domains, where a first lookup table of the plurality of lookup tables is associated with a first administrative domain of the plurality of administrative domains, where the first administrative domain corresponds to an L2 network that is disconnected from any router in the networking environment. In some embodiments, the operations include generating, based on the network data, a workload identification table that maps combinations of IP addresses and administrative domains to workloads, receiving the flow record from the observation point, and identifying a source workload and a destination workload of the flow record using the observation point mapping information, the first lookup table, and the workload identification table.

### BRIEF DESCRIPTION OF THE DRAWINGS

FIG. 1 depicts a logical network environment, in which embodiments of the present application may be implemented.

FIG. 2 depicts a plurality of tables for the network depicted in FIG. 1, according to an example embodiment of the present application.

FIG. 3 depicts a plurality of tables, including a disconnected device lookup table and a management entity lookup table for the network environment from FIG. 1, according to an example embodiment of the present application.

FIG. 4 depicts a block diagram of a physical implementation of the network environment from FIG. 1, according to one or more embodiments.

FIG. 5 depicts a flowchart for workload identification for IP addresses in flow records, according to an example embodiment of the present application.

FIG. 6 depicts a flowchart for using a disconnected device lookup table and a management entity lookup table for domain resolution of a flow record, according to an example embodiment of the present application.

### DETAILED DESCRIPTION

Embodiments presented herein relate to systems and methods for workload identification in network flows. In this specification, the terms “logical network entity,” “logical network element,” and the like will refer to software defined networking (SDN) logical overlay network features. The terms, “virtual entities” and the like will refer to software-implemented networking services that reside in a distributed manner on a plurality of physical host computers and may handle logical overlay or physical underlay network traffic. In so doing, virtual entities, which include software-implemented switches, routers, tunnel endpoints, network filters/firewalls, etc., implement policies for the overlay software-defined network.

In particular, aspects of the present application include techniques for workload identification in network flows in situations where a first workload is not connected to a router (such as a first router), meaning a first L2 network to which the first workload is connected is not connected to a router, and a second workload connected to a second L2 network is connected to a router, and the first L2 network and second L2 network have the same subnet IP address prefix.

Certain aspects of the present application provide an enhancement to the techniques discussed in U.S. Pat. No. 10,873,513, which was granted on Dec. 22, 2020 and is titled “Workload Identification for Network Flows in Hybrid Environments with Non-Unique IP Addresses, and which is incorporated by reference herein in its entirety. In particular, aspects of the present application provide a disconnected device table and/or a manager domain table that are capable of mapping L3 disconnected workloads accurately for workload identification, as further discussed herein. These embodiments improve the functioning of computer networks by accurately mapping topology, allowing for correct analysis and troubleshooting.

Techniques described herein constitute an improvement in networking technology, as they allow for flow records to be fully disambiguated in hybrid network environments that may comprise L3 disconnected workloads. As further discussed herein, using network routing and topology information to determine administrative domains, observation point mapping information, lookup tables for administrative domains, and workload identification tables allows for flow records to be enriched with disambiguating information, and thereby improves conventional industry practice. Advantageously, the ability to uniquely identify source and destination workloads of flow records in hybrid network environments significantly enhances the analysis of such flow records, and improves the utility of decisions made based on such analysis.

It is understood that techniques described herein, such as identification of administrative domains and their relationships, can also be applied to other networking related problems like routing, reachability, and various types of analytics. While embodiments are described herein with respect to particular networking problems such as flow data desegregation and de-duplication, other embodiments may be employed without departing from the scope of the present disclosure.

Furthermore, while certain techniques are described herein as involving the use of tables, it is understood that other types of data structures may be employed. Tables are merely included in this disclosure as one example, and any manner of storing associations among data may be used. For example, the tables may be implemented using a variety of types of data structures other than tables without departing from the scope of the present disclosure, such as hashes, vectors, stateless databases, databases, tree structures, etc.

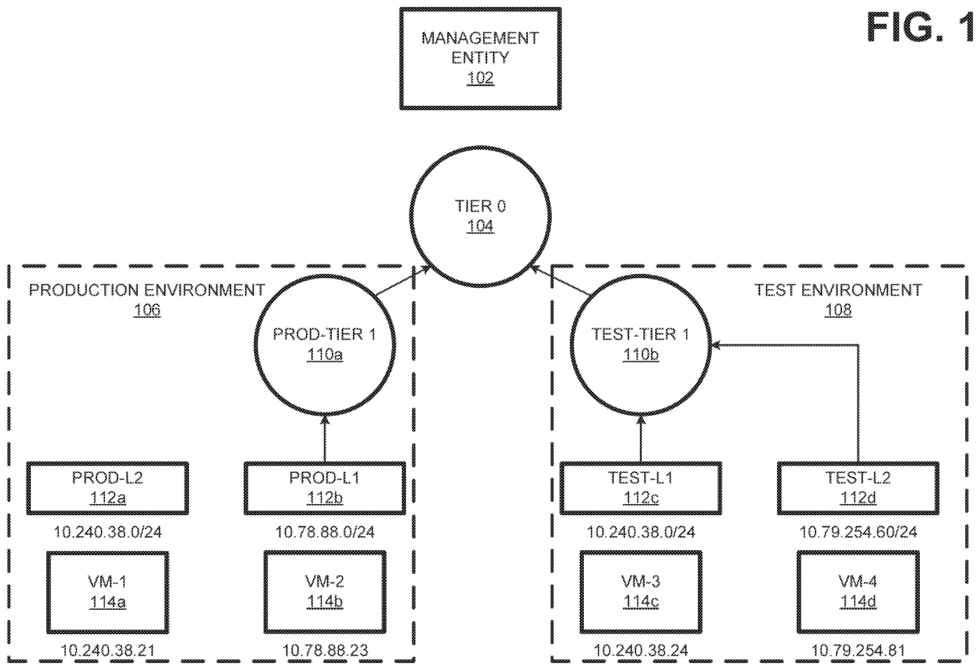

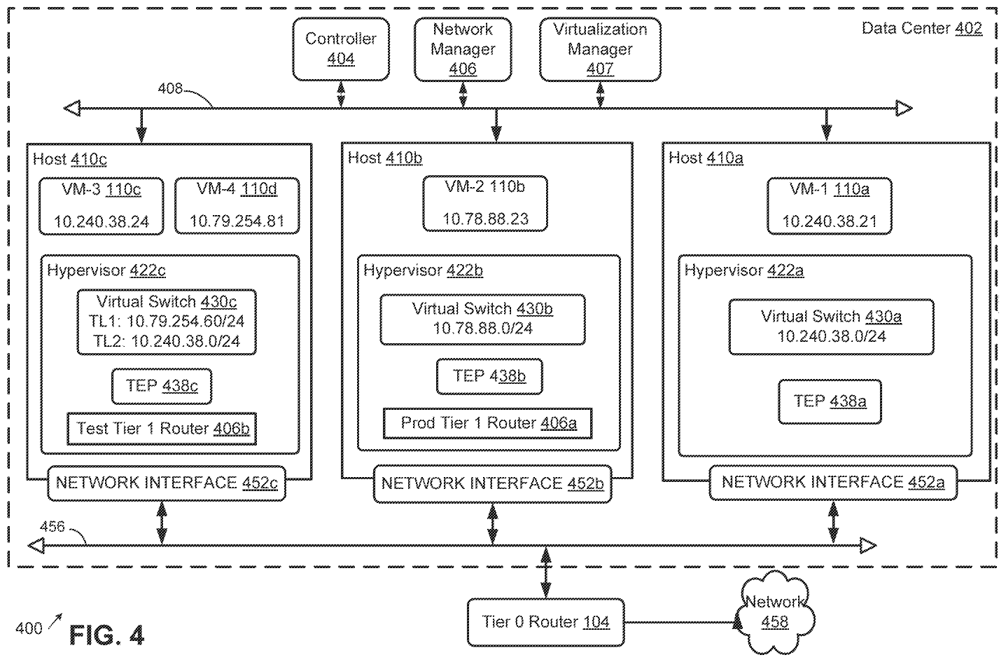

Referring now to the drawings, FIG. 1 depicts an example network environment, in which embodiments of the present application may be implemented. As illustrated, the network environment depicts a management entity 102. The network environment depicted in FIG. 1 illustrates logical entities of a logical network that may be implemented in physical hardware as further discussed with respect to FIG. 4. The management entity 102 may be configured a manager for software defined networks (SDN) such as logical overlay networks, or other network manager, such as those provided by Acure™, Microsoft™, Cisco™, Nuage™, Juniper™, etc. The management entity 102 may identify workloads in network flows according to the techniques discussed herein. The management entity 102 is configured to provide management functions for the logical entities of the logical network, as further discussed with respect to FIG. 4.

The network environment includes a tier 0 router 104. The tier 0 router 104 may be configured as a physical router or a logical router and may provide workloads with access to an external network, such as the internet. Coupled to the tier 0 router 104 are a production environment 106 and a test environment 108. The production environment 106 includes a production tier 1 router (“prod-tier 1”) 110a, production L2 network (“prod-L2”) 112a, production L1 network (“prod-L1”) 112b, and workloads, such as such as at least one virtual machine VM-1 114a, and VM-2 114b. The test environment 112 includes a test environment tier 1 router 110b (“test-tier 1”), test L1 network 112c, test-L2 network 112d, and workloads, such as at least one virtual machine VM-1 114c and VM-1 114d. Each of the networks 112 represents a logical switch, and accordingly, an L2 network. Logical switches can connect arbitrary devices on a common broadcast domain that serves as the logical network. In one example, a set of managed edge switches are configured to encapsulate packets from source endpoints such as a source VMs and tunnel the encapsulated packets over a physical network to destination managed edge switches, which then decapsulates the packets and forwards the decapsulated packets to the destination endpoints, such as destination VMs. From the perspective of the source and destination virtual machines, they may all reside on logical networks and hence are connected directly to one another via corresponding logical switches. The logical switches are implemented by the managed edge switches by way of their configurations. An advantage of logical networks is that they can be isolated from each other even though the addressing overlaps or conflict. For example, logical network identifiers may be inserted into the tunnel headers of packets sent between managed edge switches to disambiguate which logical network each packet belongs to without relying on the 5-tuple.

Specifically, the network environment of FIG. 1 is depicted as having a production environment 106 and a test environment 108. The test environment 108 may be utilized for testing configurations, software, devices, etc. for use in the production environment 106. The production environment 106 may be utilized for actual use and implementation of the configurations, software, devices, etc. Though certain aspects are described with respect to a network environment with a test environment 108 and a production environment 106, it should be noted that the techniques herein are similarly applicable to other network environments.

In certain aspects, the prod-tier 1 router 110a and the test-tier 1 router 110b each may be a logical router and may provide workloads with access to the tier 0 router 104 and/or other networks or endpoints (e.g., workloads or other network endpoints not shown).

As shown, the production environment 106 includes two layer 2 (L2) networks, prod-L2 network 112a and prod-L1 network 112b. Prod-L2 network 112a and prod-L1 network 112b may correspond to separate logical switches. The prod-L2 network 112a as shown has an associated subnet IP address prefix of 10.240.38.0/24. One or more workloads may be coupled to the prod-L2 network 112a, such as VM-1 114a, which has been assigned an IP address of 10.240.38.21 in the IP subnet of prod-L2 network 112a. As illustrated, while the prod-L2 network 112a is part of the production environment 106, the prod-L2 network 112a is not connected to the prod-tier 1 router 110a (or another router).

The prod-L1 network 112b as shown has an associated subnet IP address prefix of 10.78.88.0/24. One or more workloads may be coupled to the prod-L1 network 112b, such as VM-2 114b, which has been assigned an IP address of 10.78.88.23 in the IP subnet of prod-L1 network 112b. As illustrated, prod-L1 network 112b is connected to the prod-tier 1 router 110a.

As shown, the test environment 108 includes two L2 networks, test-L1 network 112c and test-L2 network 112d. Test-L1 network 112c and test-L2 network 112d may correspond to separate logical switches. The test-L1 network 112c as shown has an associated subnet IP address prefix of 10.240.38.0/24, which is the same IP subnet as prod-L2 network 112a. One or more workloads may be coupled to test-L1 network 112c, such as VM-3 114c, which has been assigned an IP address of 10.240.38.24 in the IP subnet of test-L1 network 112c. As illustrated, test-L1 network 112c is connected to test-tier 1 router 110b.

The test-L2 network 112d as shown has an associated subnet IP address prefix of 10.79.254.60/24. One or more workloads may be coupled to the test-L2 network 112d, such as VM-4 114d, which has been assigned an IP address of 10.79.254.81 in the IP subnet of test-L2 network 112d. As illustrated, test-L2 network 112d is connected to test-tier 1 router 110b.

As will be understood, the prod-L2 network 112a and the test-L1 network 112c have the same IP subnet addressing. In other words, despite being distinct logical networks that are logically isolated from one another, they are associated with identical network prefixes, which causes inconsistencies in lookup tables created for the network. As discussed above, this may cause issues in analysis and troubleshooting.

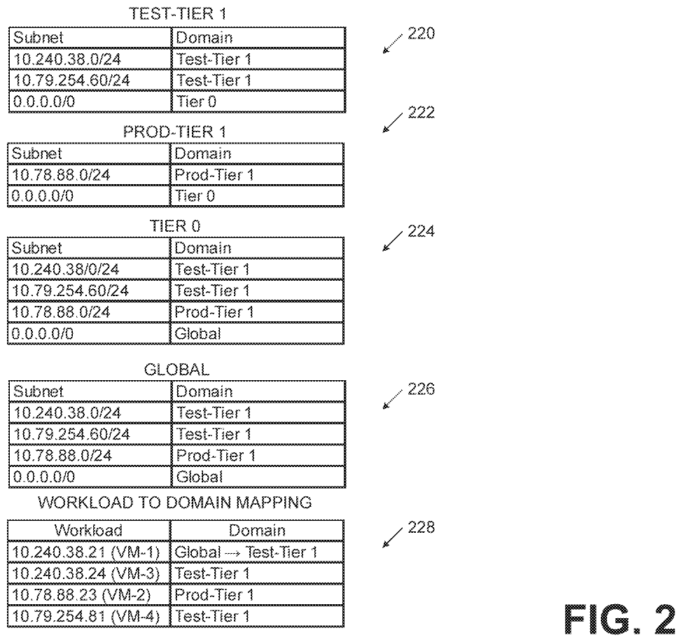

FIG. 2 depicts a plurality of lookup tables for the network depicted in FIG. 1, according to an example embodiment of the present application. Specifically, the lookup tables of FIG. 2 may be generated by management entity 102 based on flow records received from various observation points. The flow records may be records of network traffic that are captured by one or more observation points and sent to the management entity 102. The flow records may include netflow records. Netflow is set of techniques for collecting and analyzing recorded network traffic (or “flows”) to determine network state. The flow records may include “5-tuples,” which include a source IP address, a destination IP address, a source port, a destination port, and a protocol. Flow records may further include observation point information about the observation point at which the record was captured, such as an IP address or other identifier of the entity that captured the flow record.

Management entity 102 may collect and analyze flow records in order to determine security policies, identify dependencies, migrate workloads, allocate resources, and/or the like. For example, management entity 102 may be associated with a service provider (e.g., a cloud provider, provider of database services, streaming services, web services, or the like) that serves a plurality of endpoints in a hybrid network environment. Key components in the process of analyzing flow records are segregation and deduplication of flow records, as well as identifying workloads associated with flow records. However, because a network environment may include non-unique IP addresses, it may be difficult to identify a source and destination workload of a flow record based on a source and destination IP address. These obstacles to accurately determining the workload information for source and destination IP addresses constitute a significant challenge and prevent visibility into traffic patterns and application dependencies based on unsegregated flow records having overlapping IP addresses.

U.S. Pat. No. 10,873,513, granted Dec. 22, 2020 and titled, “Workload Identification for Network Flows in Hybrid Environments with Non-Unique IP Addresses” describes techniques for identifying a source and destination workload of a flow record even in a network environment that includes non-unique IP addresses. In particular, this patent describes techniques for aggregating (e.g., by management entity 102) network data such as topology and routing data from a plurality of endpoints (e.g., routers, switches, gateways, firewalls, and the like) throughout the network environment, and using this network data to create a detailed network topology. Management entity 102 may then utilize the network topology for determination of administrative domains (e.g., network views) within which every IP address is unique. An administrative domain (AD) is a logical segment in a network topology such that all observation points within it have the same network view. A network view can include all potentially reachable IP addresses from an observation point. For example, a global administrative domain may correspond to a logical segment including all workloads. Further, in some aspects, an AD may correspond to a logical segment from the view of a router.

After determining a plurality of administrative domains, as discussed in U.S. Pat. No. 10,873,513, management entity 102 may generate, based on the network topology, observation point mapping information that maps observation points to administrative domains. For example, within each administrative domain, management entity 102 may identify each workload within the administrative domain and add an entry to the observation point mapping information that maps the administrative domain to each observation point that observes the workload. Management entity 102 may then generate a plurality of lookup tables based on the network topology, each lookup table being associated with a particular administrative domain, and each lookup table mapping IP subnets (e.g., groups of IP addresses) to administrative domains. For example if IP addresses within a first administrative domain can communicate with particular IP subnets within a second administrative domain, the lookup table for the first administrative domain will map the particular IP subnets to the second administrative domain (e.g., if these IP subnets are encountered within a flow record observed within the first administrative domain, then the table will indicate that they belong to workloads within the second administrative domain). Management entity 102 may also generate a workload identification table that maps workloads to combinations of IP addresses and administrative domains. For example, each workload may be mapped to an <IP address, administrative domain> pair.

Further, according to U.S. Pat. No. 10,873,513, in a runtime process, management entity 102 may receive flow records and use techniques described therein to identify a source and destination workload of each flow record. For example, management entity 102 may use the observation point mapping information to determine the administrative domain of the observation point of a flow record (e.g., based on observation point information in the flow record). Management entity 102 may then select a lookup table based on the administrative domain of the observation point (e.g., the lookup table that is associated with the administrative domain), and use the lookup table to determine source and destination administrative domains (e.g., based on source and destination IP addresses included in the flow record). In some embodiments, management entity 102 may generate a 7-tuple that includes the information from the 5-tuple included in the flow record (e.g., source IP address, destination IP address, source port, destination port, and protocol) as well as the source and destination administrative domains. This 7-tuple fully disambiguates the flow record within the network environment, as it allows workloads to be uniquely identified regardless of which portion the flow record was received from.

In addition, according to U.S. Pat. No. 10,873,513, management entity 102 may use the workload identification table to identify a source workload and a destination workload of the flow record. For example, management entity 102 may use a combination of the source IP address and the source administrative domain to identify the source workload in the workload identification table. Similarly, management entity 102 may use a combination of the destination IP address and the destination administrative domain to identify the destination workload in the workload identification table. Having uniquely identified the source and destination workloads associated with each flow record, management entity 102 may proceed with analysis operation based on the flow records. For example, management entity 102 may use the flow records to determine security policies, identify dependencies, migrate workloads, allocate resources, and the like.

However, the techniques discussed in U.S. Pat. No. 10,873,513 may not be able to properly identify workloads in situations where a first workload is not connected to a router, meaning a first L2 network to which the first workload is connected is not connected to a router, and a second workload connected to a second L2 network is connected to a router, and the first L2 network and second L2 network have the same subnet IP address prefix.

For example, FIG. 2 illustrates the tables that may be created for the network environment from FIG. 1 according to the techniques of U.S. Pat. No. 10,873,513. Specifically, lookup table 220 comprises the lookup table for an AD corresponding to a network view of test-tier 1 router 110b, which may be referred to as the AD of test-tier 1 router 110b. Each subnet that is potentially reachable from within the AD of test-tier 1 router 110b is mapped to the AD in which it is located. In particular, as shown in lookup table 220, the IP subnet of test-L1 network 112c. 10.240.38.0/24, is mapped to the AD of test-tier 1 router 110b. Further, the IP subnet of test-L2 network 112d, 10.79.254.60/24, is mapped to the AD of test-tier 1 router 110b. All other IP addresses, as represented by the all-inclusive subnet 0.0.0.0/0 that matches all IP addresses, are mapped to the AD of tier 0 router 104 as from the view of test-tier 1 router 110b, all traffic not in subnet 10.240.38.0/24 or subnet 10.79.254.60/24 would be handled via tier 0 router 104.

Lookup table 222 comprises the lookup table for an AD corresponding to a network view of prod-tier 1 router 110a, which may be referred to as the AD of prod-tier 1 router 110a. Each subnet that is potentially reachable from within the AD of prod-tier 1 router 110a is mapped to the AD in which it is located. In particular, as shown in lookup table 222, the IP subnet of prod-L1 network 112b, 10.78.88.0/24, is mapped to the AD of prod-tier 1 router 110a. As prod-L2 network 112a is not connected to prod-tier 1 router 110a, the subnet of prod-L2 network 112a, 10.240.38.0/24, is not directly reachable via prod-tier 1 router 110a. Therefore, there is no entry in lookup table 222 for the subnet of prod-L2 network 112a, 10.240.38.0/24. All other IP addresses, as represented by the all-inclusive subnet 0.0.0.0/0 that matches all IP addresses, are mapped to the AD of tier 0 router 104 as from the view of prod-tier 1 router 110a, all traffic not in subnet 10.78.88.0/24 would be handled via tier 0 router 104.

Lookup table 224 comprises the lookup table for an AD corresponding to a network view of tier 0 router 104, which may be referred to as the AD of tier 0 router 104. Each subnet that is potentially reachable from within the AD of tier 0 router 104 is mapped to the AD in which it is located. In particular, as shown in lookup table 224, the IP subnet of test-L1 network 112c. 10.240.38.0/24, is mapped to the AD of test-tier 1 router 110b. Further, the IP subnet of test-L2 network 112d, 10.79.254.60/24, is mapped to the AD of test-tier 1 router 110b. In addition, as shown in lookup table 224, the IP subnet of prod-L1 network 112b, 10.78.88.0/24, is mapped to the AD of prod-tier 1 router 110a. As prod-L2 network 112a is not connected to prod-tier 1 router 110a, and therefore not reachable by tier 0 router 104, no entry corresponding to prod-L2 network 112a is added to lookup table 224. All other IP addresses, as represented by the all-inclusive subnet 0.0.0.0/0 that matches all IP addresses, are mapped to the global AD, which is the default AD for workloads not in a specific AD. Lookup table 226 comprises the lookup table for the global AD, and is a copy of the lookup table 224, as the tier 0 router 104 has a view of the entire network.

Also provided in FIG. 2 is a workload to AD mapping table 228. Workload to AD mapping table 228 maps the IP addresses of workloads in the network environment from FIG. 1 to their ADs. In the present example, the workloads include VM-1 114a, VM-2 114b, VM-3 114c, and VM-4 114d. Workload to AD mapping table 228 is generated using AD lookup tables 220-226.

In particular, the IP address of VM-1, 10.240.38.21, is in the IP subnet 10.240.38.0/24. Lookup table 226 indicates that IP subnet 10.240.38.0/24 is in the AD of test-tier 1 router 110b. Therefore, workload to AD mapping table 228 has an entry mapping the IP address of VM-1 to the AD of test-tier 1 router 110b. However, this is incorrect, as VM-1 is not reachable via test-tier 1 router 110b. Therefore, there will be an incorrect domain resolution, and VM-1 will not be resolved for a flow record indicating a source or destination IP address as the IP address of VM-1.

Table 1 below further illustrates incorrect resolution of ADs for flow records that may result based on lookup tables 220-226, leading to an inability to properly identify workloads associated with the flow records. In particular, the incorrect resolution of ADs is based on the prior techniques not properly accounting for L3 disconnected workloads. Table 1 illustrates a plurality of cases of how example flow records received at management entity 102 would be resolved by management entity 102 based on lookup tables 220-226. Each case in Table 1 represents a flow record from a workload in the indicated source subnet to a workload in the indicated destination subnet. The source AD: from source perspective column in Table 1 provides the AD of the source workload as would be determined using lookup tables 220-226 when the flow record is received from an observation point in the source subnet. The destination AD: from source perspective column in Table 1 provides the AD of the destination workload as would be determined using lookup tables 220-226 when the flow record is received from an observation point in the source subnet. The source AD: from destination perspective column in Table 1 provides the AD of the source workload as would be determined using lookup tables 220-226 when the flow record is received from an observation point in the destination subnet. The destination AD: from destination perspective column in Table 1 provides the AD of the destination workload as would be determined using lookup tables 220-226 when the flow record is received from an observation point in the destination subnet.

Specifically, in case 1, the source subnet is prod-L2 network 112a and the destination subnet is prod-L1 network 112b. Thus, the source administrative domain from the source perspective and the destination perspective resolves first to the global AD, which based on the lookup table 226 of the global AD resolves to the AD of test-tier 1 router 110b. However, this is incorrect as discussed. Similarly, in case 2, where the source subnet is again prod-L2 network 112a and the destination subnet is test-L2 network 112d, Table 1 again incorrectly indicates that the source administrative domain from source perspective and destination perspective is the AD of test-tier 1 router 110b.

In case 5, where the source subnet and the destination subnet are both prod-L2 network 112a, the source administrative domain from source perspective, the destination administrative domain from source perspective, source administrative domain all incorrectly resolve to the AD of test-tier 1 router 110b.

In case 7, where the source subnet is again prod-L2 network 112a and the destination subnet is an internet IP 8.8.8.8, Table 1 again incorrectly indicates that the source administrative domain from source perspective and destination perspective is the AD of test-tier 1 router 110b.

TABLE 1

| | | | Source | Destination | Source | Destination |
|---|---|---|---|---|---|---|
| | | | AD: From | AD: from | AD: From | AD: From |
| | Source | Destination | Source | Source | Destination | Destination |
| Case | Subnet | Subnet | Perspective | Perspective | Perspective | Perspective |
| 1 | Prod-L2 | Prod-L1 | Global −> | Prod-Tier 1 | N/A | Prod-Tier 1 |
| | | | Test-Tier 1 | | | |
| | | | (Incorrect) | | | |
| 2 | Prod-L2 | Test-L2 | Global −> | Test-Tier 1 | N/A | Test- Tier 1 |
| | | | Test-Tier 1 | | | |
| | | | (Incorrect) | | | |
| 3 | Test-L2 | Test-L1 | Test-Tier 1 | Test-Tier 1 | Test-Tier 1 | Test-Tier 1 |
| 4 | Prod-L1 | Prod-L1 | Prod-L1 | Prod-L1 | Prod-L1 | Prod-L1 |
| 5 | Prod-L2 | Prod-L2 | Global −> | Global −> | Global −> | Global −> |
| | | | Test-Tier 1 | Test-Tier 1 | Test-Tier 1 | Test-Tier 1 |
| | | | (Incorrect) | (Incorrect) | (Incorrect) | (Incorrect) |
| 6 | Prod-L1 | 8.8.8.8 | Prod-Tier 1 | GLOBAL | Prod-Tier 1 | GLOBAL |
| 7 | Prod-L2 | 8.8.8.8 | Global −> | GLOBAL | Global −> | GLOBAL |
| | | | Test-Tier 1 | | Test-Tier 1 | |
| | | | (Incorrect) | | (Incorrect) | |
| 8 | Test-L1 | 8.8.8.8 | Test-Tier 1 | GLOBAL | Test-Tier 1 | GLOBAL |
| 9 | Test-L2 | 8.8.8.8 | Test-Tier 1 | GLOBAL | Test-Tier 1 | GLOBAL |

Table 2 illustrates administrator domains for each of the networks prod-L1 network 112a, prod-L2 network 112b, test-L1 network 112c, and test-L2 network 112d, based on lookup tables 220-226. As described above, because the prod-L2 network 112a is not coupled to a router (i.e., disconnected), the associated administrator domain is incorrect in Table 2.

TABLE 2

| Network | | Virtual | Administrator |
|---|---|---|---|
| Name | Subnet | Machine | Domain |
| Prod-L1 | 10.78.88.0/24 | VM-2: 10.78.88.23 | Prod-Tier 1 |
| Prod-L2 | 10.240.38.0/24 | VM-1: 10.240.38.21 | Global −> |
| | | | Test-Tier 1 |
| Test-L1 | 10.240.38.0/24 | VM-3: 10.240.38.24 | Test-Tier 1 |
| Test-L2 | 10.79.254.60/24 | VM-4: 10.79.254.18 | Test-Tier 1 |

Accordingly, techniques herein provide for the creation of a disconnected device lookup table and a management entity lookup table. The disconnected device lookup table may be utilized to properly account for disconnected L2 network workflows in hybrid networks such that proper workflow may be mapped. These new tables may be used to provide correct domain resolution even when there are L3 disconnected workloads in the network environment. The correct domain resolution can be used to properly identify an L3 disconnected workload as the source and/or destination workload in a flow record.

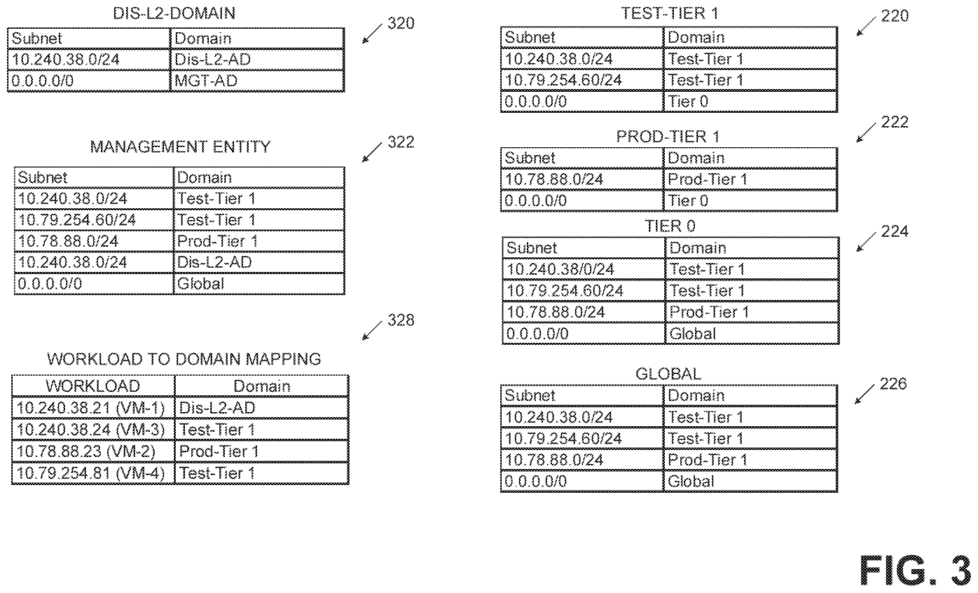

FIG. 3 depicts a plurality of tables, including a disconnected device lookup table 320 and a management entity lookup table 322 for the network environment from FIG. 1, according to an example embodiment of the presently described technology. Specifically, the management entity 102 may determine, based on network topology information received as discussed, which L2 networks (e.g., which logical switches) are not connected to a router (e.g., Tier 1 router). Further, the management entity 102 may associate the subnet of each such L2 network not connected to a router with an AD, referred to as a disconnected AD.

In particular, management entity 102 creates disconnected device lookup table 320, which associates the subnets associated with L2 networks not connected to a router, in the network environment managed by management entity 102, with their corresponding disconnected AD. For example, disconnected device lookup table 320 maps the subnet 10.240.38.0/24 of prod-L2 network 112a to disconnected AD “dis-L2-AD.” Disconnected device lookup table 320 also includes an entry for all IP addresses not associated with an L2 network that is not connected to a router, the entry associating all-inclusive subnet 0.0.0.0/0 with an AD of management entity 102 (“MGT-AD”).

Management entity lookup table 322 corresponds to the MGT-AD lookup table for management entity 102. Management entity 102 creates management entity lookup table 322 to include the same entries as global AD lookup table 226 as discussed herein, as well as the entries of disconnected device lookup table 320 that correspond to subnets of L2 networks not connected to a router.

Additionally, because the disconnected device lookup table 320 properly associates the subnets associated with L2 networks that are not connected to a router, a workload to AD domain mapping table 328 may be accurately populated with mappings of all workloads in the network, including a proper representation of VM-1 114a as being disconnected.

Using disconnected device lookup table 320 and a management entity lookup table 322, the management entity 102 may correctly identify VM-1 114a as a source and/or destination workload of a flow record. In particular, Tables 3 and 4 as compared to Tables 1 and 2, illustrate a correct domain mapping of the disconnected prod-L2 network 112a. As also illustrated in FIG. 3, lookup tables 220, 222, 224, and 226 from FIG. 2 remain unchanged in this embodiment. Table 3 illustrates the observation point mapping information that maps observation points associated with the subnet to determine an administrative domain that is mapped to the subnet. Table 4 illustrates the workload association with the subnet and administrator domain.

TABLE 3

| | | | Source | Destination | Source | Destination |
|---|---|---|---|---|---|---|
| | | | AD: From | AD: from | AD: From | AD: From |
| | Source | Destination | Source | Source | Destination | Destination |
| Case | Subnet | Subnet | Perspective | Perspective | Perspective | Perspective |
| 1 | Prod-L2 | Prod-L1 | Dis-L2-Domain | Prod-Tier 1 | N/A | Prod-Tier 1 |
| 2 | Prod-L2 | Test-L2 | Dis-L2-Domain | Test-Tier 1 | N/A | Test- Tier 1 |
| 3 | Test-L2 | Test-L1 | Test-Tier 1 | Test-Tier 1 | Test-Tier 1 | Test-Tier 1 |
| 4 | Prod-L1 | Prod-L1 | Prod-L1 | Prod-L1 | Prod-L1 | Prod-L1 |
| 5 | Prod-L2 | Prod-L2 | Dis-L2-Domain | Dis-L2-Domain | Dis-L2-Domain | Dis-L2-Domain |
| 6 | Prod-L1 | 8.8.8.8 | Prod-Tier 1 | GLOBAL | Prod-Tier 1 | GLOBAL |
| 7 | Prod-L2 | 8.8.8.8 | Dis-L2-Domain | GLOBAL | Dis-L2-Domain | GLOBAL |
| 8 | Test-L1 | 8.8.8.8 | Test-Tier 1 | GLOBAL | Test-Tier 1 | GLOBAL |
| 9 | Test-L2 | 8.8.8.8 | Test-Tier 1 | GLOBAL | Test-Tier 1 | GLOBAL |

TABLE 4

| Network | | Virtual | Administrator |
|---|---|---|---|
| Name | Subnet | Machine | Domain |
| Prod-L1 | 10.78.88.0/24 | VM-2: 10.78.88.23 | Prod-Tier 1 |
| Prod-L2 | 10.240.38.0/24 | VM-1: 10.240.38.21 | Dis-L2-Domain |
| Test-L1 | 10.240.38.0/24 | VM-3: 10.240.38.24 | Test-Tier 1 |
| Test-L2 | 10.79.254.60/24 | VM-4: 10.79.254.18 | Test-Tier 1 |

FIG. 4 depicts a block diagram of a plurality of hosts implementing the network environment shown in FIG. 1, according to one or more embodiments. Networking environment 400, corresponding the network environment shown in FIG. 1, includes a set of networked computing entities, and may implement a logical overlay network. Networking environment 400 includes a data center and an external network 458, which may be a wide area network such as the Internet.

The data center includes hosts 410, a management network 408, a data network 456, a controller 404, a network manager 406, and a virtualization manager 407. Data network 456 and management network 408 may be implemented as separate physical networks or separate virtual local area networks (VLANs) on the same physical network. The data center 402 includes a management plane (MP) and a control plane. The management plane and control plane each may be implemented as single entities (e.g., applications running on a physical or virtual compute instance), or as distributed or clustered applications or components. In alternative embodiments, a combined manager/controller application, server cluster, or distributed application, may implement both management and control functions. In the embodiment shown, network manager 406 at least in part implements the management plane and controller 404 at least in part implements the control plane.

Network manager 406 receives network configuration input from an administrator and generates desired state data that specifies how a logical network should be implemented in the physical infrastructure of the data center. Network manager 406 may communicate with host(s) 410 via management network 408.

Controller 404 determines the logical overlay network topology and maintains information about network entities such as logical switches, logical routers, and endpoints, etc. The logical topology information is translated by the controller 404 into network configuration data that is then communicated to network elements of host(s) 410. Controller 404 communicates with host(s) 410 via management network 408, such as through control plane protocols.

In an embodiment, virtualization manager 407 is a computer program that executes in a central server in the data center (e.g., the same or a different server than the server on which network manager 406 executes). Virtualization manager 407 is configured to carry out administrative tasks for the data center, including managing hosts 410, managing VCIs running within each host 410, provisioning VCIs, transferring VCIs from one host to another host, transferring VCIs between data centers, transferring application instances between VCIs or between hosts 410, and load balancing among hosts 410 within the data center.

Host(s) 410, including host 410a, host 410b, and host 410c, may be communicatively connected to data network 456 and management network 408. Data network 456 and management network 408 are physical or “underlay” networks. As used herein, the term “underlay” is synonymous with “physical” and refers to physical components of networking environment 400. As used herein, the term “overlay” may be used synonymously with “logical” and refers to the logical network implemented at least partially within networking environment 400.

Host(s) 410 may be geographically co-located servers on the same rack or on different racks in any arbitrary location in the data center. Host(s) 410 may be configured to provide a virtualization layer, also referred to as a hypervisor 422, that abstracts processor, memory, storage, and networking resources of a hardware platform (not shown) into multiple virtual machines VM(s), such as VM-1 114a, VM-2 114b, VM-3 114c, and VM-4 114d. In some embodiments, hosts maintain a plurality of VCIs comprising namespace containers, such as Docker containers, running directly on the operating system of the host, or within VMs running on the host.

Virtualization software may be installed as system level software or logic directly on the server hardware (often referred to as “bare metal” installation) and be conceptually interposed between the physical hardware and the guest operating systems executing in the virtual machines. In some embodiments, the virtualization software may conceptually run “on top of” a conventional host operating system in the server. In some implementations, hypervisor 422 may comprise system level software as well as a “Domain 0” or “Root Partition” virtual machine (not shown) which is a privileged machine that has access to the physical hardware resources of the host. In this implementation, one or more of a virtual switch, virtual router, tunnel endpoint (TEP), etc., along with hardware drivers, may reside in the privileged virtual machine. Although parts of the disclosure are described with reference to VMs, the teachings herein also apply to other types of VCIs, such as containers, Docker containers, data compute nodes, isolated user space instances, namespace containers, and the like.

Host(s) 410 may be constructed on a server grade hardware platform (not shown), such as an x86 architecture platform. The hardware platform of a host 410 may include components of a computing device such as one or more processors (CPUs), system memory, one or more network interfaces 452 (e.g., PNICs), storage system, and other components (not shown). A CPU is configured to execute instructions, for example, executable instructions that perform one or more operations described herein and that may be stored in the memory and storage system. The network interface(s) enable host 410 to communicate with other devices via a physical network, such as management network 408, data network 456, and/or external network 458.

Hypervisors 422a, 422b, 422c each include a virtual switch, such a virtual switches 430a, 430b, 430c, and TEPs 438a, 438b, 438c. TEPs 438 may be configured to encapsulate and decapsulate packets in order to tunnel overlay traffic over the physical underlay. Hypervisors 422b, 422c also include virtual router(s), such as prod tier 1 router 406a and test tier 1 router 406b, which in part implement logical routers prod tier 1 router 110a and test tier 1 router 110b, respectively.

Virtual switches 430a, 430b, 430c serve as a software-based interface between network interfaces(s) 452 and VMs 114, running on host 410. Virtual switches 430 may be a virtual distributed switch (VDS). A VDS functions as a single virtual switch managed across multiple hosts 410. Virtual router(s) route traffic for a respective host 410. As such, the virtual switch 430a may implement in part the logical switch corresponding to the IP subnet of the prod L2 network 112a. The virtual switch 430b may implement in part the logical switch corresponding to the IP subnet of the prod L1 network 112b. Similarly, the virtual switch 430c may implement in part the logical switches corresponding to the IP subnets of the test L1 network 112c and the test L1 network 112d.

Also provided in the example of FIG. 4 is tier 0 router 104. As will be understood, the tier 0 router may be a hardware router, depending on the particular embodiment. The management entity 102 of FIG. 1 may correspond to network manager 406 and/or virtualization manager 407.

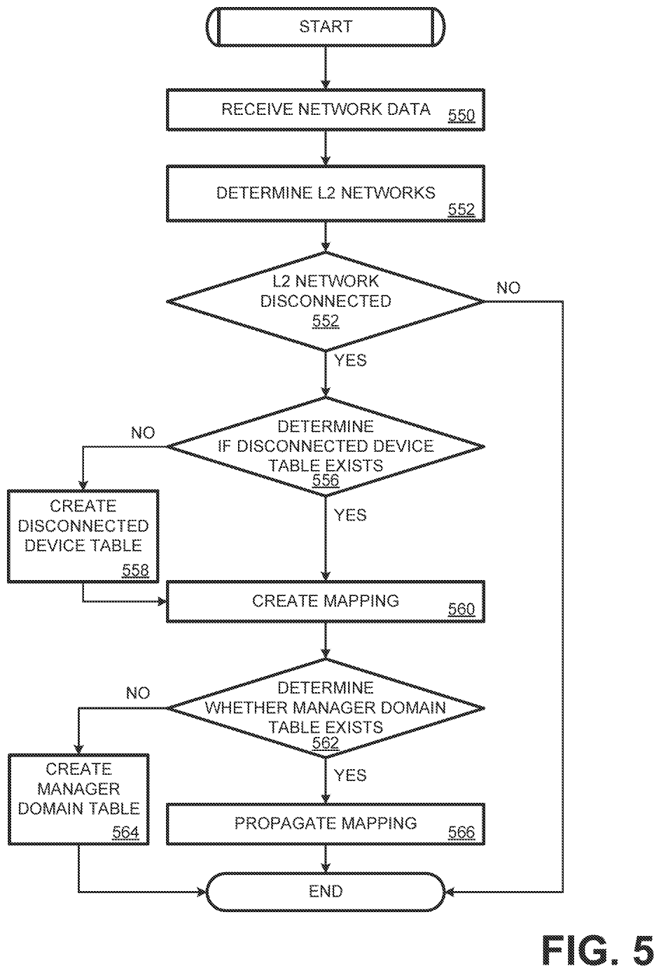

FIG. 5 depicts a flowchart for generating a disconnected device lookup table and a management entity lookup table, according to an example embodiment of the present application. As illustrated in block 550, management entity 102 receives network data for the network environment managed by the management entity 102, including workload IP addresses, IP subnets, etc. In block 552, management entity 102 utilizes the network data to determine all L2 networks in the network environment managed by management entity 102. For example, management entity 102 receives network data such as topology and routing data (e.g., identification of subnets corresponding to L2 networks) from a plurality of endpoints (e.g., routers, switches, gateways, firewalls, workloads, hosts, and/or the like) throughout the network environment, and uses this network data to create a detailed network topology that includes the L2 networks of the network environment.

In block 554 a determination may be made regarding whether an L2 network in the network is disconnected. If not, the process may end. If, there is at least one disconnected L2 network, the process proceeds to block 556. In block 556, a determination may be made regarding whether a disconnected device lookup table exists. If not, the process proceeds to block 558 to create a disconnected device lookup table. The disconnected device table may include a field for an IP subnet and a field for a domain of the endpoint. If, at block 556, it is determined that a disconnected device lookup table exists or after the disconnected device table is created, in block 560, a mapping is propagated for the disconnected device lookup table.

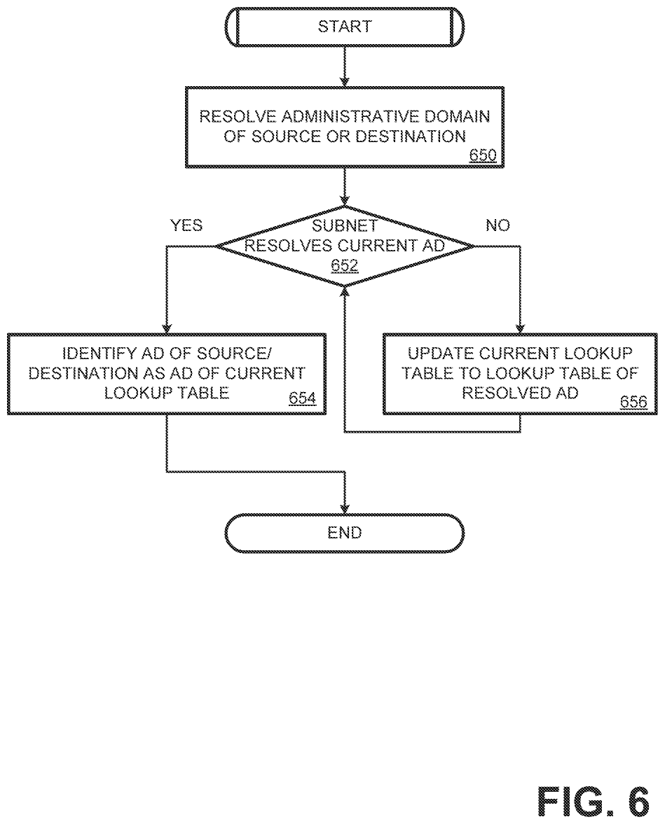

In block 562, a determination is made regarding whether a management entity lookup table exists. If not, in block 564, a management entity lookup table is created. The management entity lookup table may include an IP subnet and a domain for a component managed by the management entity. If the management entity lookup table already exists or after the management entity lookup table is created, in block 566, a mapping is propagated into the management entity lookup table. In some embodiments, other lookup tables, such as a global lookup table that includes an IP subnet and a domain for all components in the network may also be created. Once the lookup tables are created and populated the lookup tables may be utilized, such as described with reference to FIG. 6

FIG. 6 depicts a flowchart for using a disconnected device lookup table and a management entity lookup table for domain resolution of a flow record, according to an example embodiment of the present application. The flow record includes an indication of a source IP address of the flow, a destination IP address of the flow, and an indication, such as an identifier, of the observation point at which the flow is observed. In an example, the source of the flow is VM-1 114a (source IP address 10.240.38.21) and the destination of the flow is VM-2 114b (destination IP address 10.78.88.23). Further, the flow record may be received by management entity 102 from VM-1 114a.

Accordingly, at block 650, management entity 102 uses the lookup table associated with the administrative domain of the observation point associated with the flow record as the current lookup table to resolve the administrative domain of the source or destination of the flow. In an example, the management entity 102 sets the current lookup table to lookup table 320 of FIG. 3 based on the observation point being VM-1 114a, which is in the Dis-L2-AD administrative domain.

At block 652, management entity 102 determines whether, in the current lookup table, the subnet associated with the IP address of the source or destination of the flow resolves to the same administrative domain as the administrative domain associated with the current lookup table. In one example, the source IP address 10.240.38.21 of the flow is in the subnet 10.240.38.0/24 indicated in current lookup table 320. The subnet 10.240.38.0/24 resolves to the administrative domain Dis-L2-AD in current lookup table 320. Administrative domain Dis-L2-AD is also the administrative domain of the current lookup table 320. Therefore, the process continues to block 654, where the administrative domain of the source or destination of the flow is identified as the administrative domain of the current lookup table, and the process ends. In the example, therefore, the administrative domain of the source of the flow is identified as Dis-L2-AD.

In another example, the destination IP address 10.78.88.23 of the flow is only in the subnet 0.0.0.0/0 indicated in current lookup table 320. The subnet 0.0.0.0/0 resolves to the administrative domain MGT-AD in current lookup table 320. Administrative domain MGT-AD is not the same as the administrative domain Dis-L2-AD of current lookup table 320, and therefore the process proceeds to block 656. At block 656, the resolved administrative domain of the source or destination of the flow based on the current lookup table is used to update the current lookup table to the lookup table of the resolved administrative domain. In the example, the resolved administrative domain is MGT-AD based on current lookup table 320 is MGT-AD, and therefore, the current lookup table is updated to lookup table 322 associated with MGT-AD.

The process then returns to block 652. In the example, at block 652, the destination IP address 10.78.88.23 of the flow is in the subnet 10.78.88.0/24 indicated in current lookup table 322. The subnet 10.78.88.0/24 is associated with the administrative domain Prod-Tier 1 in lookup table 322, which is not the same as the administrative domain MGT-AD associated with current lookup table 322. Accordingly, at block 656, the current lookup table is updated to lookup table 222 associated with Prod-Tier 1. Returning to block 652, the destination IP address 10.78.88.23 of the flow is in the subnet 10.78.88.0/24 indicated in current lookup table 222. The subnet 10.78.88.0/24 resolves to the administrative domain Prod-Tier 1 in current lookup table 222. Administrative domain Prod-Tier 1 is also the administrative domain of the current lookup table 222. Therefore, the process continues to block 654, where the administrative domain of the source or destination of the flow is identified as the administrative domain of the current lookup table, and the process ends. In the example, therefore, the administrative domain of the destination of the flow is identified as Prod-Tier 1.

The various embodiments described herein may employ various computer-implemented operations involving data stored in computer systems. For example, these operations may require physical manipulation of physical quantities usually, though not necessarily, these quantities may take the form of electrical or magnetic signals where they, or representations of them, are capable of being stored, transferred, combined, compared, or otherwise manipulated. Further, such manipulations are often referred to in terms, such as producing, identifying, determining, or comparing. Any operations described herein that form part of one or more embodiments may be useful machine operations. In addition, one or more embodiments also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments may be implemented as one or more computer programs or as one or more computer program modules embodied in one or more computer readable media. The term computer readable medium refers to any data storage device that can store data which can thereafter be input to a computer system computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), NVMe storage, Persistent Memory storage, a CD (Compact Discs), CD-ROM, a CD-R, or a CD-RW, a DVD (Digital Versatile Disc), a magnetic tape, and other optical and non-optical data storage devices. The computer readable medium can be a non-transitory computer readable medium. The computer readable medium can also be distributed over a network coupled computer system so that the computer readable code is stored and executed in a distributed fashion. In particular, one or more embodiments may be implemented as a non-transitory computer readable medium comprising instructions that, when executed by at least one processor of a computing system, cause the computing system to perform a method, as described herein.

Although one or more embodiments of the present application have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of one or more embodiments. In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s). In the claims, elements and/or steps do not imply any particular order of operation, unless explicitly stated in the claims.

What is claimed is:

1. A method for identifying workloads in a networking environment based on a flow record from an observation point, the method comprising:
receiving network data from one or more endpoints in the networking environment, wherein the network data comprises topology data and routing data;
determining, based on the network data, a plurality of administrative domains within the networking environment, wherein each of the plurality of administrative domains comprises a distinct section of the networking environment within which every Internet Protocol (IP) address is unique;
generating, based on the network data, observation point mapping information that maps each observation point within the networking environment to one of the plurality of administrative domains;
generating, based on the network data, a plurality of lookup tables, wherein each of the plurality of lookup tables is associated with one of the plurality of administrative domains, wherein each of the plurality of lookup tables maps IP subnets to administrative domains, wherein a first lookup table of the plurality of lookup tables is associated with a first administrative domain of the plurality of administrative domains, wherein the first administrative domain corresponds to an L2 network that is disconnected from any router in the networking environment;
generating, based on the network data, a workload identification table that maps combinations of IP addresses and administrative domains to workloads;
receiving the flow record from the observation point; and
identifying a source workload and a destination workload of the flow record using the observation point mapping information, the first lookup table, and the workload identification table.

2. The method of claim 1, wherein generating the plurality of lookup tables comprises:
determining, based on the network data, one or more disconnected L2 networks exist in the networking environment, wherein the L2 network is one of the one or more L2 disconnected L2 networks; and
generating the first lookup table based on determining the one or more disconnected L2 networks exist in the networking environment, wherein the first lookup table includes a separate entry for each of the one or more disconnected L2 networks.

3. The method of claim 1, wherein identifying the source workload and the destination workload comprises:
determining the source workload is associated with a first IP address in a first subnet associated with the L2 network;
determining the observation point is associated with the first administrative domain;
selecting the first lookup table based on the observation point being associated with the first administrative domain;
determining the first subnet is associated with the first administrative domain in the first lookup table; and
determining the source workload is in the first administrative domain based on the first administrative domain being associated with both the first lookup table and the first subnet.

4. The method of claim 1, wherein the flow record comprises an IP address of the source workload as a source IP address, an IP address of the destination workload as a destination IP address, a source port, a destination port, and a protocol.

5. The method of claim 1, wherein each of the plurality of lookup tables comprises an entry corresponding to a default subnet of 0.0.0.0/0.

6. The method of claim 1, wherein identifying the source workload and the destination workload comprises:
determining the destination workload is associated with a first IP address in a first subnet;
determining the observation point is associated with a second administrative domain;
selecting a second lookup table based on the observation point being associated with the second administrative domain;
determining the second lookup table does not include an entry specific to the first subnet and maps a default subnet to a third administrative domain;
selecting a third lookup table associated with the third administrative domain;
determining the third lookup table maps the first subnet to a fourth administrative domain;
selecting a fourth lookup table associated with the fourth administrative domain;
determining the first subnet is associated with the further administrative domain in the fourth lookup table; and
determining the destination workload is in the fourth administrative domain based on the fourth administrative domain being associated with both the fourth lookup table and the first subnet.

7. The method of claim 6, wherein:
the observation point comprises a first tier 1 router,
the third administrative domain is associated with a tier 0 router; and
the fourth administrative domain is associated with a second tier 1 router.

8. A system for identifying workloads in a networking environment based on a flow record from an observation point, the system comprising:
at least one processor; and
at least one memory, the at least one processor and the at least one memory configured to cause the system to:
receive network data from one or more endpoints in the networking environment, wherein the network data comprises topology data and routing data;
determine, based on the network data, a plurality of administrative domains within the networking environment, wherein each of the plurality of administrative domains comprises a distinct section of the networking environment within which every Internet Protocol (IP) address is unique;
generate, based on the network data, observation point mapping information that maps each observation point within the networking environment to one of the plurality of administrative domains;
generate, based on the network data, a plurality of lookup tables, wherein each of the plurality of lookup tables is associated with one of the plurality of administrative domains, wherein each of the plurality of lookup tables maps IP subnets to administrative domains, wherein a first lookup table of the plurality of lookup tables is associated with a first administrative domain of the plurality of administrative domains, wherein the first administrative domain corresponds to an L2 network that is disconnected from any router in the networking environment;
generate, based on the network data, a workload identification table that maps combinations of IP addresses and administrative domains to workloads;
receive the flow record from the observation point; and
identify a source workload and a destination workload of the flow record using the observation point mapping information, the first lookup table, and the workload identification table.

9. The system of claim 8, wherein generating the plurality of lookup tables comprises:
determining, based on the network data, one or more disconnected L2 networks exist in the networking environment, wherein the L2 network is one of the one or more L2 disconnected L2 networks; and
generating the first lookup table based on determining the one or more disconnected L2 networks exist in the networking environment, wherein the first lookup table includes a separate entry for each of the one or more disconnected L2 networks.

10. The system of claim 8, wherein identifying the source workload and the destination workload comprises:
determining the source workload is associated with a first IP address in a first subnet associated with the L2 network;
determining the observation point is associated with the first administrative domain;
selecting the first lookup table based on the observation point being associated with the first administrative domain;
determining the first subnet is associated with the first administrative domain in the first lookup table; and
determining the source workload is in the first administrative domain based on the first administrative domain being associated with both the first lookup table and the first subnet.

11. The system of claim 8, wherein the flow record comprises an IP address of the source workload as a source IP address, an IP address of the destination workload as a destination IP address, a source port, a destination port, and a protocol.

12. The system of claim 8, wherein each of the plurality of lookup tables comprises an entry corresponding to a default subnet of 0.0.0.0/0.

13. The system of claim 8, wherein identifying the source workload and the destination workload comprises:
determining the destination workload is associated with a first IP address in a first subnet;
determining the observation point is associated with a second administrative domain;
selecting a second lookup table based on the observation point being associated with the second administrative domain;
determining the second lookup table does not include an entry specific to the first subnet and maps a default subnet to a third administrative domain;
selecting a third lookup table associated with the third administrative domain;
determining the third lookup table maps the first subnet to a fourth administrative domain;
selecting a fourth lookup table associated with the fourth administrative domain;
determining the first subnet is associated with the further administrative domain in the fourth lookup table; and
determining the destination workload is in the fourth administrative domain based on the fourth administrative domain being associated with both the fourth lookup table and the first subnet.

14. The system of claim 13, wherein:
the observation point comprises a first tier 1 router,
the third administrative domain is associated with a tier 0 router; and
the fourth administrative domain is associated with a second tier 1 router.

15. A non-transitory computer-readable medium for identifying workloads in a networking environment based on a flow record from an observation point, comprising instructions that, when executed by at least one processor of a computing system, cause the computing system to perform operations for virtual computing instance remediation, the operations comprising:
receiving network data from one or more endpoints in the networking environment, wherein the network data comprises topology data and routing data;
determining, based on the network data, a plurality of administrative domains within the networking environment, wherein each of the plurality of administrative domains comprises a distinct section of the networking environment within which every Internet Protocol (IP) address is unique;
generating, based on the network data, observation point mapping information that maps each observation point within the networking environment to one of the plurality of administrative domains;
generating, based on the network data, a plurality of lookup tables, wherein each of the plurality of lookup tables is associated with one of the plurality of administrative domains, wherein each of the plurality of lookup tables maps IP subnets to administrative domains, wherein a first lookup table of the plurality of lookup tables is associated with a first administrative domain of the plurality of administrative domains, wherein the first administrative domain corresponds to an L2 network that is disconnected from any router in the networking environment;
generating, based on the network data, a workload identification table that maps combinations of IP addresses and administrative domains to workloads;
receiving the flow record from the observation point; and
identifying a source workload and a destination workload of the flow record using the observation point mapping information, the first lookup table, and the workload identification table.

16. The non-transitory computer-readable medium of claim 15, wherein generating the plurality of lookup tables comprises:
determining, based on the network data, one or more disconnected L2 networks exist in the networking environment, wherein the L2 network is one of the one or more L2 disconnected L2 networks; and
generating the first lookup table based on determining the one or more disconnected L2 networks exist in the networking environment, wherein the first lookup table includes a separate entry for each of the one or more disconnected L2 networks.

17. The non-transitory computer-readable medium of claim 15, wherein identifying the source workload and the destination workload comprises:
determining the source workload is associated with a first IP address in a first subnet associated with the L2 network;
determining the observation point is associated with the first administrative domain;
selecting the first lookup table based on the observation point being associated with the first administrative domain;
determining the first subnet is associated with the first administrative domain in the first lookup table; and
determining the source workload is in the first administrative domain based on the first administrative domain being associated with both the first lookup table and the first subnet.

18. The non-transitory computer-readable medium of claim 15, wherein the flow record comprises an IP address of the source workload as a source IP address, an IP address of the destination workload as a destination IP address, a source port, a destination port, and a protocol.

19. The non-transitory computer-readable medium of claim 15, wherein each of the plurality of lookup tables comprises an entry corresponding to a default subnet of 0.0.0.0/0.

20. The non-transitory computer-readable medium of claim 15, wherein identifying the source workload and the destination workload comprises:
determining the destination workload is associated with a first IP address in a first subnet;
determining the observation point is associated with a second administrative domain;
selecting a second lookup table based on the observation point being associated with the second administrative domain;
determining the second lookup table does not include an entry specific to the first subnet and maps a default subnet to a third administrative domain;
selecting a third lookup table associated with the third administrative domain;
determining the third lookup table maps the first subnet to a fourth administrative domain;
selecting a fourth lookup table associated with the fourth administrative domain;
determining the first subnet is associated with the further administrative domain in the fourth lookup table; and
determining the destination workload is in the fourth administrative domain based on the fourth administrative domain being associated with both the fourth lookup table and the first subnet,
wherein the observation point comprises a first tier 1 router,
wherein the third administrative domain is associated with a tier 0 router; and
wherein the fourth administrative domain is associated with a second tier 1 router.
